(19) United States
(12) Patent Application Publication
(10) Pub. No.: US 2022/0242257 A1
(43) Pub. Date: Aug. 4, 2022

(54) FOREIGN MATTER DETECTION DEVICE, POWER TRANSMISSION DEVICE, POWER RECEPTION DEVICE, AND POWER TRANSMISSION SYSTEM

(71) Applicant: TDK CORPORATION, Tokyo (JP)

(72) Inventor: Akira GOTANI, Tokyo (JP)

(73) Assignee: TDK CORPORATION, Tokyo (JP)

(21) Appl. No.: 17/629,643

(22) PCT Filed: Dec. 4, 2020
(86) PCT No.: PCT/JP2020/045219

§ 371 Date: Jan. 24, 2022

(30) Foreign Application Priority Data
Dec. 27, 2019 (JP) 2019-239627

(51) Int. Cl. B60L 53/124; H02J 50/10; H02J 50/60; H02J 50/40; H01F 38/14

(52) U.S. Cl. CPC B60L 53/124; H02J 50/10; H01F 38/14; H02J 50/402; H02J 50/60

(57) ABSTRACT

A foreign object detection device includes coils (242) arranged adjacent to each other on an arrangement surface, each of which is excited and thus generates a vibration signal, and a detector (26) connected to the coils (242) to detect the existence of a foreign object on the basis of the responding signal output from each of the coils (242). The arrangement surface has a first region in which the coils (242) are grouped into a plurality of first coil groups each containing at least two coils (242). The detector (26) detects the existence of a foreign object on the basis of the vibration signal output from each of the coils (242) contained in the first coil groups. The first coil groups contain mutually different combinations of coils (242), and one coil (242) contained in at least one first coil group is also contained in another first coil group.

### TECHNICAL FIELD

The present disclosure relates to a foreign object detection device, a power transmission device, a power reception device, and a power transfer system.

### BACKGROUND ART

Recent interest has been focused on wireless power transfer techniques for transferring electric power without a power supply cable. These wireless power transfer techniques can achieve wireless transmission of electric power from a power transmission device to a power reception device, and are therefore expected to be applied to various products, for example, transport equipment, such as trains and electric vehicles, home appliances, electronic equipment, and wireless communication equipment.

The wireless power transfer techniques use a power transmission coil and a power reception coil magnetically coupled to each other for the purpose of power transmission. Unfortunately, an unwelcomed foreign object, such as a metal fragment, may exist in the vicinity of the power transmission coil and the power reception coil, and may bring about adverse effects on power transmission from the power transmission coil to the power reception coil. This problem requires a solution to appropriately detect such a foreign object existing in the vicinity of the power transmission coil and the power reception coil.

Patent Literature 1 discloses a foreign object detection device that applies a voltage to a plurality of coils for detection of a foreign object, measures a physical quantity, and determines an amount of change in comparison to a reference value, thereby detecting whether any foreign object exists in the vicinity of each coil in an apparatus for wirelessly transfer electric power. This foreign object detection device determines the existence of a foreign object on the basis of an amount of change in the physical quantity acquired after application of a voltage to each coil in comparison to the reference value. Unfortunately, this method may lead to misdetection of a foreign object, for example, when changes in environmental conditions cause a variation in the impedance of the coil, because the reference value is a fixed value. The device may erroneously detect a foreign object despite of the absence of a foreign object, for example, when the impedance of a coil is varied by external factors, such as a change in temperature and a magnetic field applied from the outside.

In order to deal with this problem, Patent Literature 2 discloses a device that compares detection signals from the two loops of an 8-shaped loop antenna with each other and thereby detects a foreign object.

### CITATION LIST

### Patent Literature

Patent Literature 1: Unexamined Japanese Patent Application Publication No. 2017-034972

Patent Literature 2: Unexamined Japanese Patent Application Publication No. 2019-017168

### SUMMARY OF INVENTION

### Technical Problem

Unfortunately, the method disclosed in Patent Literature 2 may fail to detect a foreign object when the foreign object exists across the two loops of an 8-shaped antenna or when foreign objects exit in the respective two loops of an 8-shaped antenna, because variations in magnetic fluxes detected at the respective two loops are offset by each other.

An objective of the present disclosure, which has been accomplished in view of the above situations, is to achieve more accurate detection of a foreign object existing between a power transmission coil and a power reception coil for power transfer.

### Solution to Problem

In order to solve the above problems, a foreign object detection device according to an aspect of the present disclosure includes: a plurality of coils arranged adjacent to each other on an arrangement surface, each of the coils being configured to be excited and thus generate a vibration signal; and a detector connected to the coils to detect the existence of a foreign object on the basis of the vibration signal output when each of the coils is excited. The arrangement surface has a first region in which the coils are grouped into a plurality of first coil groups each containing at least two coils, and the detector detects the existence of a foreign object on the basis of the vibration signal output from each of the coils contained in the first coil groups. The first coil groups contain mutually different combinations of coils, and one coil contained in at least one first coil group is also contained in another first coil group.

A power transmission device according to another aspect of the present disclosure may include the above-described foreign object detection device.

A power reception device according to another aspect of the present disclosure may include the above-described foreign object detection device.

A power transfer system according to another aspect of the present disclosure may include a power transmission device and a power reception device, and at least one of the power transmission device or the power reception device may include the above-described foreign object detection device.

### Advantageous Effects of Invention

The foreign object detection device having the above-described configuration can accurately detect the existence of a foreign object.

### BRIEF DESCRIPTION OF DRAWINGS

FIG. 1 illustrates an exemplary configuration of a power transfer system to which a foreign object detection device according to the present disclosure is applied;

FIG. 2 is a sectional view illustrating configurations of a power transmission coil unit, a power reception coil unit, and the foreign object detection device illustrated in FIG. 1, and corresponds to a sectional view taken along the line II-II of FIG. 3;

FIG. 3 is a plan view illustrating configurations of the power transmission coil unit and the foreign object detection device illustrated in FIG. 1;

FIG. 4 is a plan view of a detection coil unit of the foreign object detection device illustrated in FIG. 1;

FIG. 5 illustrates an exemplary equivalent circuit of the resonant circuit configured by a coil and a capacitor of a loop coil illustrated in FIG. 4, and an exemplary foreign object in the vicinity of the circuit;

FIG. 6A illustrates an exemplary transitional change in the voltage between both terminals of the resonant circuit illustrated in FIG. 5 in response to application of a pulsed voltage;

FIG. 6B illustrates an exemplary transitional change in the voltage between both terminals of the resonant circuit in response to application of a pulsed voltage in an external environment different from that of FIG. 6A;

FIG. 7 is a diagram for describing a grouping scheme of loop coils illustrated in FIG. 3;

FIG. 8 illustrates a configuration of a detector illustrated in FIG. 1;

FIG. 9 is a flowchart of a foreign object detecting process executed in a foreign object detection device according to the embodiment;

FIG. 10A illustrates an exemplary foreign object detected in the foreign object detecting process illustrated in FIG. 9;

FIG. 10B illustrates an exemplary foreign object detected in the foreign object detecting process illustrated in FIG. 9;

FIG. 11 is a plan view for describing another example of a grouping scheme of loop coils illustrated in FIG. 3;

FIG. 12 is a plan view for describing another example of a grouping scheme of loop coils illustrated in FIG. 3;

FIG. 13 is a plan view for describing another example of a grouping scheme of loop coils illustrated in FIG. 3;

FIG. 14 is a plan view for describing a modification of the detection coil substrate illustrated in FIG. 3 and another example of a grouping scheme of loop coils; and

FIG. 15 is a flowchart of a modification of the foreign object detecting process illustrated in FIG. 9.

### DESCRIPTION OF EMBODIMENTS

A foreign object detection device, a power transmission device, a power reception device, and a power transfer system according to an embodiment of the present disclosure are described below. In the following description and drawings, the corresponding components are provided with the same reference symbol. The drawings illustrate a coordinate system including the X axis, the Y axis, and the Z axis orthogonal to each other, so as to clarify the directions of components. The features, such as the number, shapes, dimensions, and dimensional ratios, of components illustrated in the drawings are mere examples and not intended to limit the technical scope of the present disclosure.

A power transfer system 1 according to the embodiment can be applied to various devices. Examples of the devices include mobile devices, such as smartphones, electric vehicles, and industrial equipment. The following description is directed to an example in which the power transfer system 1 is used for charging a rechargeable battery 5 of an electric vehicle 2.

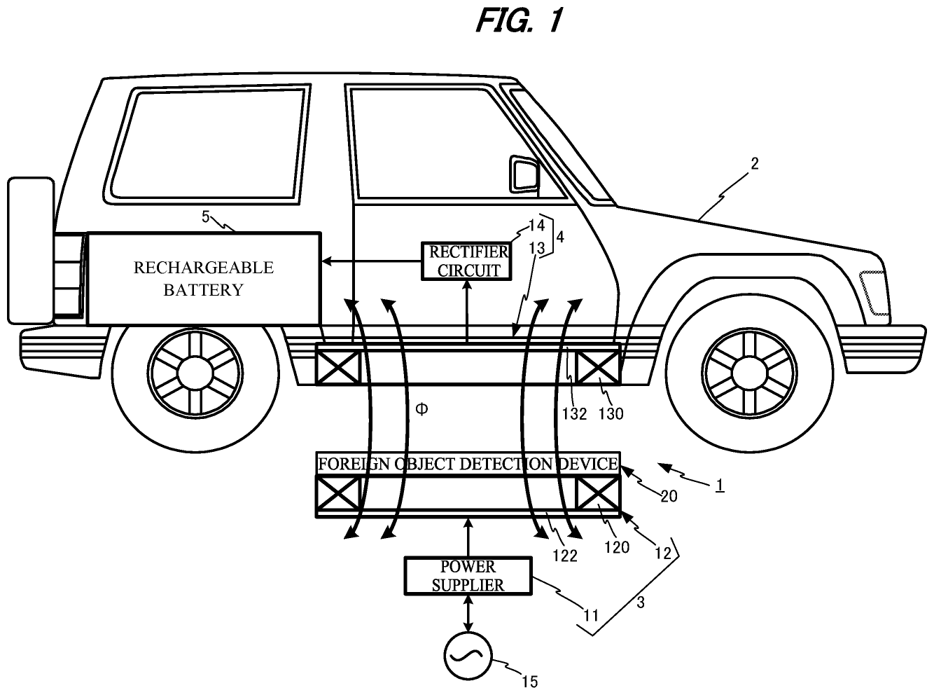

As illustrated in FIG. 1, the power transfer system 1 is a wireless power transfer system to wirelessly transfer electric power from a power transmission side to a power reception side. The power transfer system 1 includes a power transmission device 3, a power reception device 4, and a foreign object detection device 20. The power transmission device 3 is a wireless power transmission device to wirelessly transmit AC power to the electric vehicle 2. The power transmission device 3 includes a power supplier 11 and a power transmission coil unit 12.

The power supplier 11 generates AC power at a frequency of 75 to 90 kHz from a commercial power supply 15 to be transmitted, for example, and feeds the generated power to the power transmission coil unit 12.

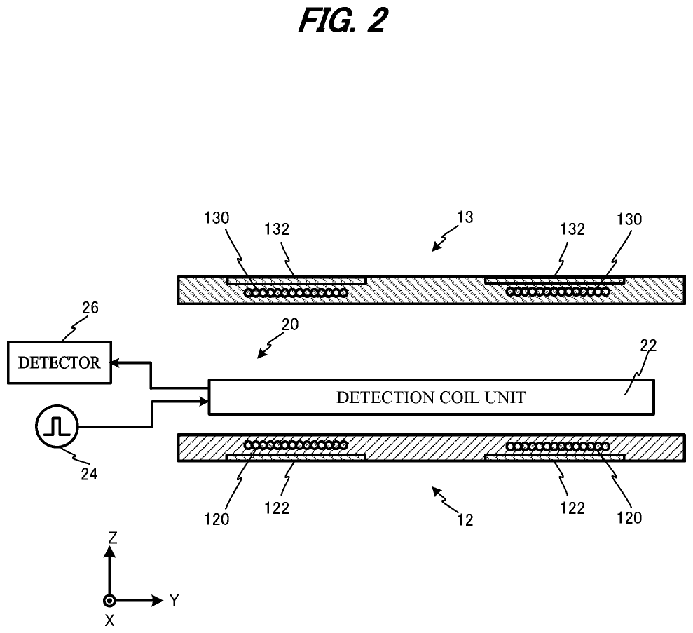

As illustrated in FIG. 2, the power transmission coil unit 12 includes a magnetic plate 122 made of a magnetic material, such as ferrite, and a power transmission coil 120 including a conductive wire coiled in a flat spiral on the magnetic plate 122. The power transmission coil 120 is fed with the AC power from the power supplier 11 and thereby induces an alternating magnetic flux 1.

The power reception device 4 illustrated in FIG. 1 is a wireless power charging device to wirelessly receive the electric power from the power transmission device 3 and charge the rechargeable battery 5. The power reception device 4 includes a power reception coil unit 13 and a rectifier circuit 14. As illustrated in FIG. 2, the power reception coil unit 13 includes a magnetic plate 132, and a power reception coil 130 including a conductive wire coiled in a flat spiral on the magnetic plate 132. The power reception coil unit 13 faces the power transmission coil unit 12 when the electric vehicle 2 stops at a predetermined position. When the power transmission coil 120 induces the alternating magnetic flux 1, which interlinks with the power reception coil 130, so that an induced electromotive force is generated at the power reception coil 130.

The rectifier circuit 14 illustrated in FIG. 1 rectifies and smooths the induced electromotive force generated at the power reception coil 130, and feeds the resulting DC power to the rechargeable battery 5 to charge the rechargeable battery 5. A charging circuit may be disposed between the rectifier circuit 14 and the rechargeable battery 5.

The foreign object detection device 20 detects whether any foreign object, such as a metal fragment, exists between the power transmission coil unit 12 and the power reception coil unit 13. The foreign object detection device 20 includes a detection coil unit 22, a pulse generator 24, and a detector 26.

The detection coil unit 22 has a flat-plate shape and is disposed on the upper surface of the power transmission coil unit 12. The detection coil unit 22 and the power transmission coil unit 12 are installed in a floor surface of a parking lot, for example, on which a foreign object, such as an empty can, may unintentionally exist.

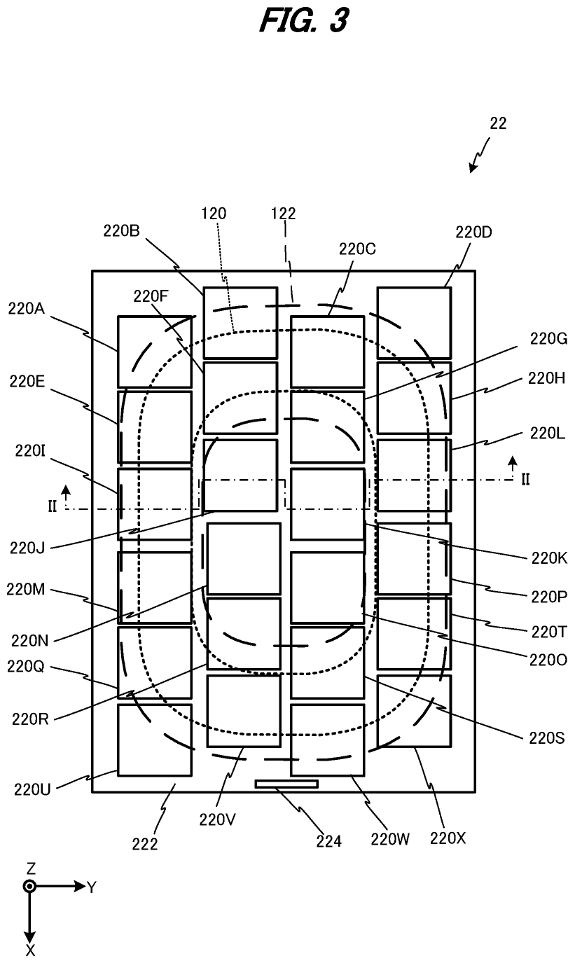

As illustrated in FIG. 3, which is a view (hereinafter referred to as “plan view”) as seen in the Z-axis direction, the detection coil unit 22 includes a detection coil substrate 222. The detection coil substrate 222 is made of a magnetically permeable material, such as resin. In this embodiment, the detection coil substrate 222 serves as an arrangement surface on which the loop coils 220 are arranged adjacent to each other, and the entire detection coil substrate 222 serves as a first region. In the first region, a plurality of coils 242 are grouped into a plurality of first coil groups, as described later. The arrangement surface of the detection coil substrate 222 for the loop coils 220 is not necessarily flat and may have protrusions and recesses.

The detection coil substrate 222 includes thereon 24 loop coils 220A to 220X arranged in a matrix in the X-axis direction and the Y-axis direction so as to be adjacent to each other and cover most of the power transmission coil unit 12, and an external connector 224 to connect the individual loop coils 220A to 220X to the pulse generator 24 and the detector 26. The loop coils are hereinafter collectively referred to as “loop coils 220” unless the description refers to a specific loop coil. The loop coils 220 in the adjacent columns extending in the X-axis direction are shifted by approximately a half-length of the loop coil 220 in the X direction. The loop coils 220 are described in detail later.

The pulse generator 24 generates a pulsed voltage for detection of a foreign object and applies the pulsed voltage to a selected loop coil 220.

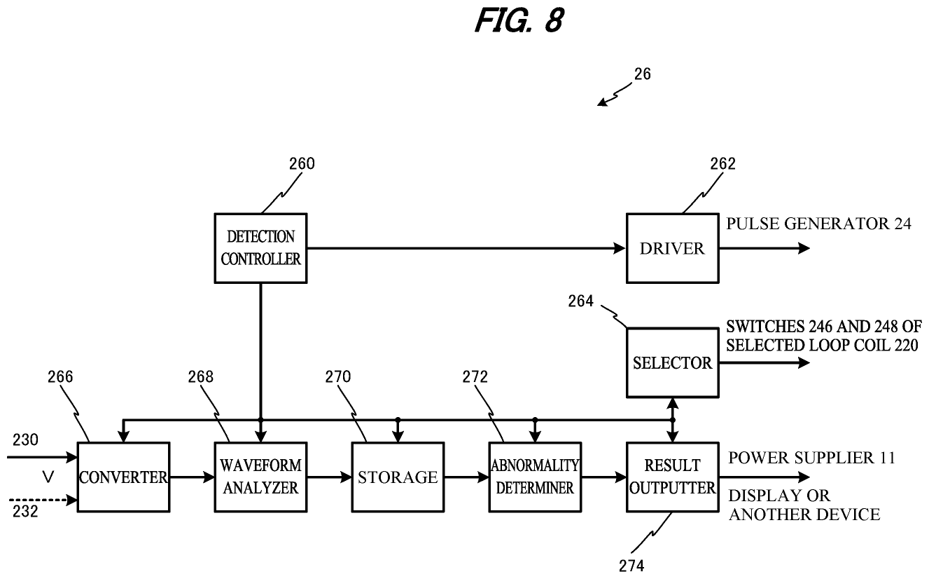

The detector 26 processes a responding vibration signal output from the loop coil 220 when the loop coil 220 is excited by application of the pulsed voltage, and thus detects whether a foreign object exists in the vicinity of the loop coil 220. The detector 26 is described in detail later with reference to FIG. 8.

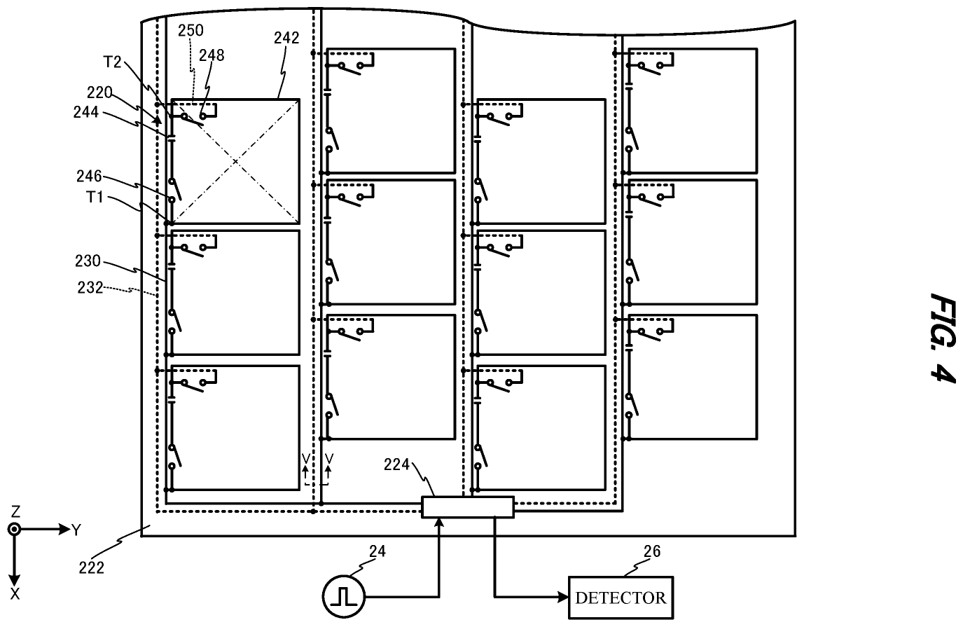

The loop coils 220 are described in detail below with reference to FIG. 4, which illustrates the circuit patterns formed on the detection coil substrate 222. FIG. 4 illustrates only twelve loop coils 220 of the loop coils 220 illustrated in FIG. 3 so as to improve the visibility of the figure.

As illustrated in FIG. 4, the loop coils 220 have configurations substantially identical to each other. Each of the loop coils 220 includes a coil 242, a capacitor 244, switches 246 and 248, and a wiring pattern 250. The reference symbols are provided to only a single loop coil 220 so as to improve the visibility of the figure.

The coil 242 includes a conductive pattern turned one or more times around the Z axis on the upper surface of the detection coil substrate 222, for example. The conductive pattern has terminals T1 and T2 at the respective ends.

The one terminal T1 of the coil 242 is connected to a first connecting line 230 and one terminal of the switch 246. The other terminal T2 of the coil 242 is connected to one terminal of the capacitor 244 and one terminal of the switch 248. The other terminal of the switch 248 is connected to one end of the wiring pattern 250. The wiring pattern 250 extends through a via hole to the lower surface of the detection coil substrate 222, then further extends on the lower surface, and leads to a second connecting line 232. The other terminal of the capacitor 244 is connected to the other terminal of the switch 246.

The switches 246 and 248 are turned on (in the conductive state) or off (in the non-conductive state), under the control of the detector 26 via a control line, which is not illustrated. The switch 246 serves to cause the connection of the coil 242 to the capacitor 244 to be switched between the conductive state and the non-conductive state. While the switch 246 is on, the coil 242 and the capacitor 244 configure a resonant circuit. The switch 248 serves to cause the connection of the resonant circuit to the pulse generator 24 to be switched between the conductive state and the non-conductive state. That is, while the switches 246 and 248 are both on, the coil 242 and the capacitor 244 configure a resonant circuit, which receives a pulsed voltage applied from the pulse generator 24 via the external connector 224, the first connecting line 230 and the second connecting line 232, and the terminals T1 and T2. In contrast, the voltage between both terminals of the resonant circuit, that is, the voltage between the terminals T1 and T2 is guided to the detector 26 via the first connecting line 230 and the second connecting line 232, and the external connector 224.

While the switch 246 is off, the coil 242 and the capacitor 244 do not configure a resonant circuit. While the switch 248 is off, the loop coil 220 is electrically disconnected from the first connecting line 230 and the second connecting line 232 and from the pulse generator 24 and the detector 26.

The 24 loop coils 220 have the identical physical properties. The identical physical properties are achieved by the identical configuration of the capacitors 244 of the 24 loop coils 220, the identical configuration of the switches 246, the identical configuration of the switches 248, and the identical configuration of the wiring patterns 250. The physical properties of the 24 loop coils 220 therefore show variations having the identical tendency in response to changes in environmental conditions, such as change in temperature, change in humidity, and change in external magnetic field.

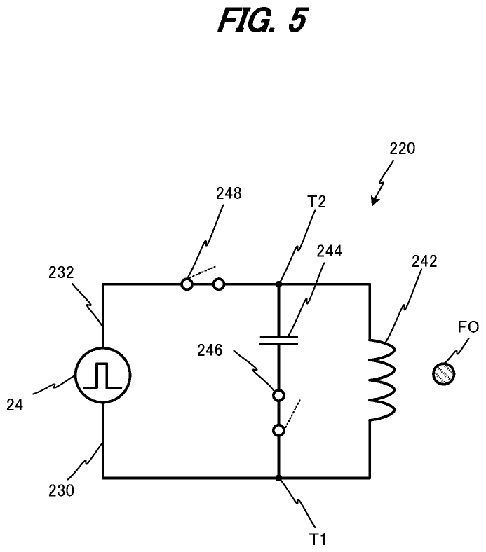

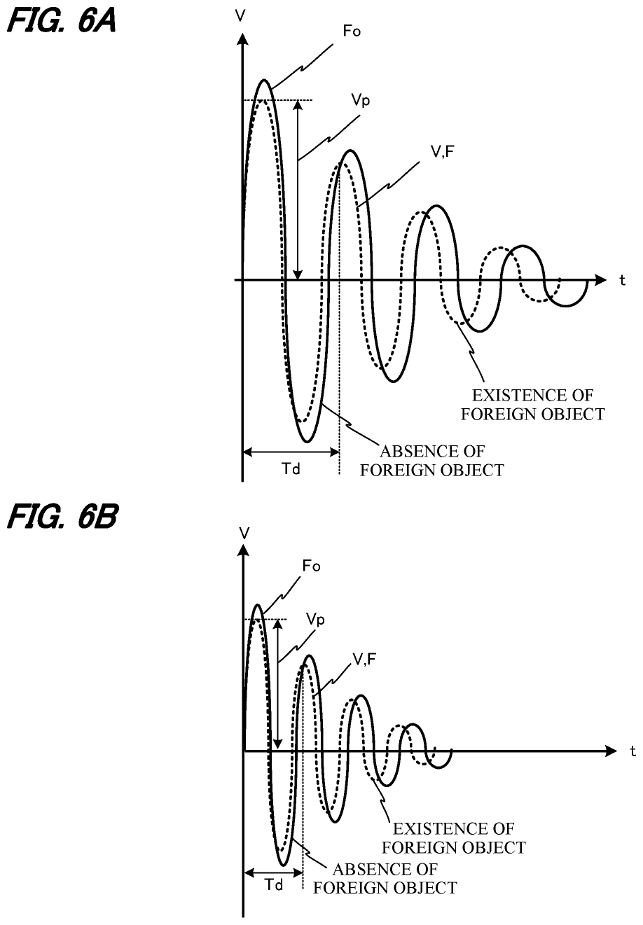

FIG. 5 illustrates an exemplary equivalent circuit of the resonant circuit configured by the coil 242 and the capacitor 244, and an exemplary foreign object (FO) in the vicinity of the circuit. FIG. 6 illustrates an exemplary transitional change in a voltage V (responding signal) in the resonant circuit generated in response to application of a single pulsed voltage from the pulse generator 24 to the resonant circuit.

In the case where the switch 246 is closed and causes the coil 242 and the capacitor 244 to configure a resonant circuit, when the switch 248 is closed and allows a single pulsed voltage to be applied from the pulse generator 24, the voltage between both terminals of the resonant circuit, that is, the voltage V between the terminals T1 and T2 corresponds to a vibration signal of which the peak value gradually attenuates as the time t passes.

The description assumes that the voltage V when no foreign object FO exists in the vicinity of the coil 242 under a reference environmental condition corresponds to a vibration signal having the waveform represented by the solid line in FIG. 6A.

In contrast, the existence of any foreign object FO, such as a metal or magnetic object, in the vicinity of the coil 242 causes a variation in the impedance of the coil 242. Accordingly, a foreign object FO existing in the vicinity of the coil 242 may cause variations in the feature quantities, which are physical quantities, such as frequency F of a vibration signal, peak voltage Vₚ in the first cycle, and time t_{d} during which the peak voltage Vₚ is approximately halved, as represented by the dotted line in FIG. 6A.

The waveform of the vibration signal also varies in response to fluctuations in the properties of the coil 242 and the capacitor 244 caused by changes in environment conditions, such as change in temperature and existence of an external magnetic field. Accordingly, a procedure of measuring the physical quantities of a vibration signal and simply comparing the measured physical quantities with fixed reference values may lead to misdetection of the existence of a foreign object FO.

Fluctuations in the physical quantities of a vibration signal caused by changes in environment conditions demonstrate the same tendency regardless of the existence or absence of a foreign object FO. In one example, changes in environmental conditions increase the frequency F of a vibration signal and decrease the peak voltage Vp and the time td in the case of the absence of a foreign object FO, as represented by the solid line in FIG. 6B. These changes in environmental conditions tend to increase the frequency F and decrease the peak voltage Vp and the time td also in the case of the existence of a foreign object FO, as represented by the dashed line in FIG. 6B.

In the present disclosure, the existence of a foreign object is determined by comparing the physical quantities of vibration signals from the resonant circuits of multiple loop coils 220 with each other. An outstanding problem is that the existence of a foreign object FO cannot be determined by a simple comparison if the foreign object FO exists in the vicinity of both of two loop coils 220.

In order to solve this problem, the existence of a foreign object is determined by comparing the physical quantities of a vibration signal from one loop coil 220 with the physical quantities of vibration signals from two other loop coils 220 in the present disclosure.

A pair of loop coils 220 between which the physical quantities are compared is hereinafter called a group (coil group). In this embodiment, 1) a group contains two adjacent loop coils 220, 2) different groups contain different combinations of loop coils 220, and 3) a loop coil 220 contained in a certain group is also contained in any of the other groups. A group of loop coils 220 corresponds to a group of coils 242 included in the loop coils 220 in other words.

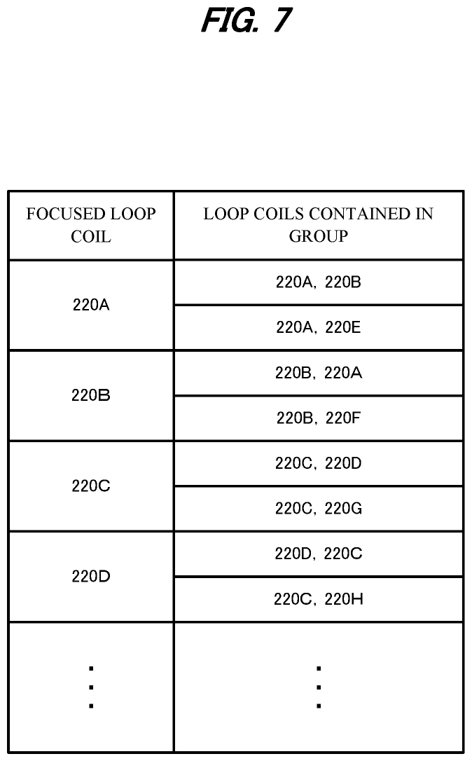

A specific example of a grouping scheme of the loop coils 220A to 220X is described below with reference to FIG. 7. The grouping scheme described below is a mere example and may be modified as appropriate.

For example, the loop coil 220A is grouped so as to form a group of the loop coils 220A and 220B and a group of the loop coils 220A and 220E. The loop coil 220B is grouped so as to form a group of the loop coils 220B and 220A and a group of the loop coils 220B and 220F. The loop coil 220C is grouped so as to form a group of the loop coils 220C and 220D and a group of the loop coils 220C and 220G. The loop coil 220D is grouped so as to form a group of the loop coils 220D and 220C and a group of the loop coils 220D and 220H. This scheme also holds true for the other loop coils 220 such that one loop coil 220 is combined with each of two loop coils 220 adjacent to the one loop coil 220.

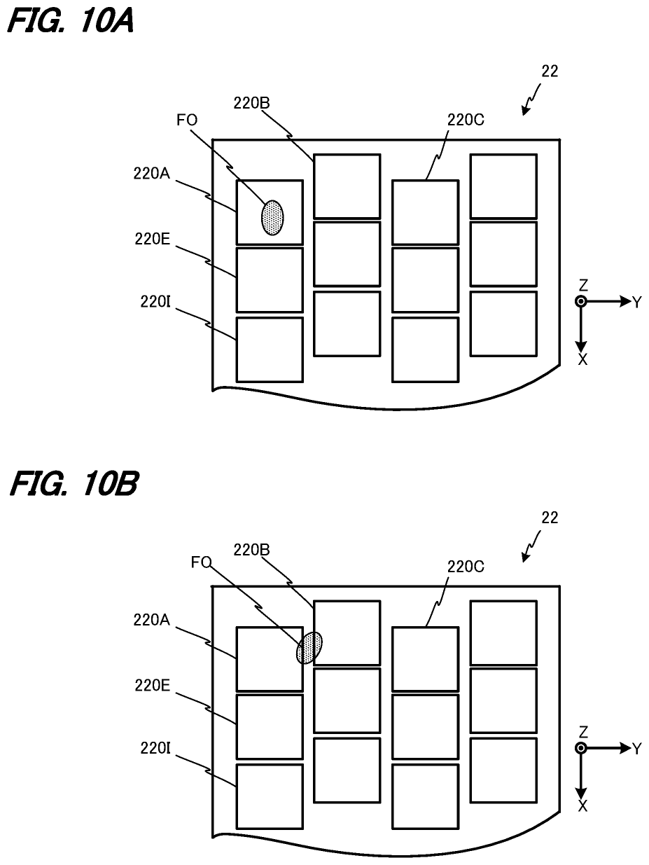

That is, the physical quantities acquired from the loop coil 220A are compared with the physical quantities acquired from the loop coil 220B, while the physical quantities acquired from the loop coil 220A are compared with the physical quantities acquired from the loop coil 220E, for example. In an exemplary case where a foreign object FO exists within the detection area of the loop coil 220A as illustrated in FIG. 10A, the physical quantities acquired from the loop coil 220A are deviated from the reference physical quantities, and therefore have significant differences from the physical quantities acquired from the loop coil 220B, which belongs to the same group as the loop coil 220A, and from the physical quantities acquired from the loop coil 220E. These differences can contribute to detection of the existence of a foreign object FO.

In another exemplary case where a foreign object FO exists across the detection areas of the loop coils 220A and 220B as illustrated in FIG. 10B, the physical quantities acquired from the loop coil 220A and the physical quantities acquired from the loop coil 220B are both deviated from the reference physical quantities in the same manner and have approximately the same values. In contrast, the physical quantities acquired from the loop coil 220E, which belongs to the other group together with the loop coil 220A, are equal to the reference physical quantities, and thus have significant differences from the physical quantities acquired from the loop coil 220A. These differences can contribute to detection of the existence of a foreign object FO.

The detector 26 illustrated in FIG. 1 selects any one of the loop coils 220A to 220X and applies a pulsed voltage to the resonant circuit of the selected loop coil. The detector 26 detects a vibration signal corresponding to a resonant signal from the resonant circuit, and acquires the feature quantities of the vibration signal. The detector 26 conducts acquisition of the feature quantities sequentially for all the loop coils 220. After completion of acquisition of the feature quantities, the detector 26 calculates the absolute values of the differences in the feature quantities between each of the loop coils 220 and the other loop coil 220 belonging to the same group, in accordance with the table of FIG. 7. If the absolute values of the differences are higher than the reference values, the detector 26 determines that the current group has abnormality. As described above, one coil 242 contained in a certain group is also contained in another group. For this reason, in the case of a foreign object existing across multiple coils 242 contained in a certain group, while the coils 242 contained in the certain group have no differences in the feature quantities and fail in abnormality determination, the one coil 242 contained in the certain group and the other coil 242 belonging to the other group together with the one coil 242 have differences in the feature quantities and can achieve abnormality determination. The detector 26 can therefore accurately detect a foreign object without errors even if the foreign object exists across multiple coils 242.

In order to perform the above-described operation, the detector 26 has a functional configuration including a detection controller 260, a driver 262, a selector 264, a converter 266, a waveform analyzer 268, a storage 270, an abnormality determiner 272, and a result outputter 274, as illustrated in FIG. 8.

The detection controller 260 controls operations of the individual components of the detector 26, so as to detect whether any foreign object exists in the vicinity of the individual loop coils 220, and output results of the detection.

The selector 264 selects any one of the loop coils 220 under the control of the detection controller 260. The selector 264 then turns on the switches 246 and 248 of the selected loop coil 220.

After completion of the selection of the loop coil 220 and turning on of the switches 246 and 248 at the selector 264, the driver 262 drives the pulse generator 24 under the control of the detection controller 260. The pulse generator 24 then outputs a single pulsed voltage. This pulsed voltage is applied to the resonant circuit via the external connector 224, the first connecting line 230 and the second connecting line 232, the terminals T1 and T2, and the switches 246 and 248 in the on states. Simultaneously, the voltage V between the terminals T1 and T2 of the resonant circuit is guided to the converter 266 via the first connecting line 230 and the second connecting line 232, and the external connector 224.

The converter 266 sequentially converts the waveform of the guided voltage in an analog format into data in a digital format and outputs the resulting data to the waveform analyzer 268, under the control of the detection controller 260.

The waveform analyzer 268 analyzes the input data on the voltage waveform, acquires the feature quantities, such as peak voltage Vₚ, time t_{d}, and frequency F, and causes these feature quantities to be stored into the storage 270, under the control of the detection controller 260.

The abnormality determiner 272 calculates the differences between the peak voltages Vₚ, between the times t_{d}, and between the frequencies F acquired from the loop coils 220 contained in each group illustrated in FIG. 7, and determines that the group has abnormality when at least one of the absolute values of the differences is larger than the reference value, under the control of the detection controller 260.

The abnormality determiner 272 determines whether at least one of the groups containing the loop coil 220 is determined to have abnormality for each of the loop coils 220, and outputs the result of detection of a foreign object to the result outputter 274.

The result outputter 274 outputs the result of detection of a foreign object to an output device, such as display, to present the detection results to a user, under the control of the detection controller 260.

The result outputter 274 also outputs the detection result stored in the storage 270 to the power supplier 11. When a detection result input before the start of wireless power transfer indicates the existence of a foreign object, the power supplier 11 does not start the operation of wireless power transfer. When a detection result input during wireless power transfer indicates the existence of a foreign object, the power supplier 11 immediately stops the operation of wireless power transfer. In contrast, when the detection result indicates the absence of a foreign object, the power supplier 11 starts the operation of wireless power transfer, or continues the operation of wireless power transfer.

In terms of hardware, the detector 26 is achieved by, for example, a computer including various interfaces, such as central processing unit (CPU), memory, and analog/digital (A/D) conversion device, and operational programs.

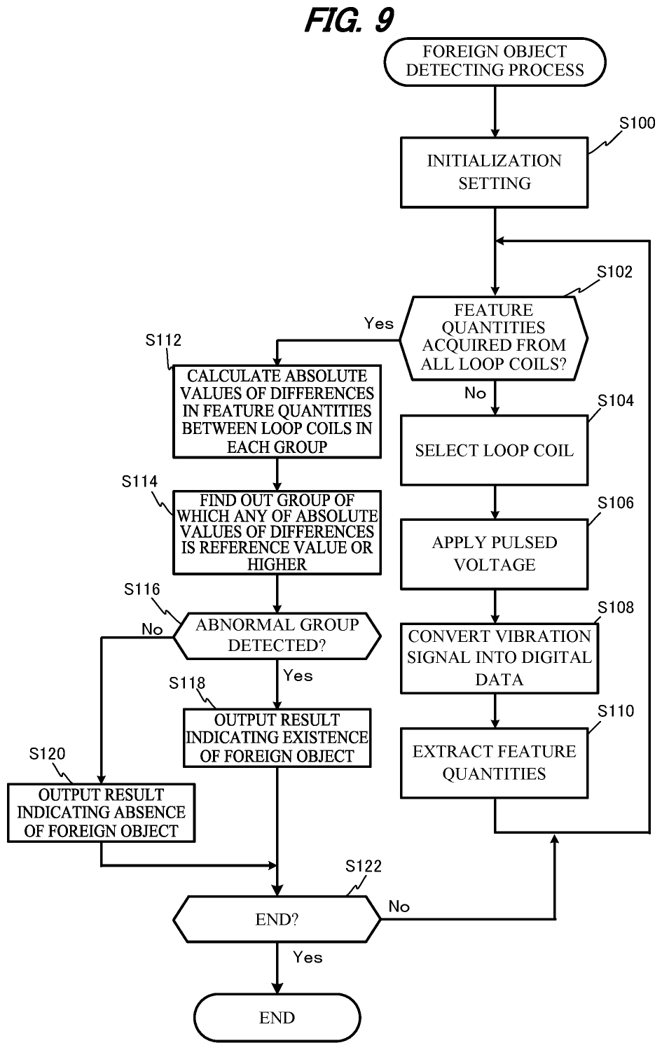

A foreign object detecting process executed in the foreign object detection device 20 is described below with reference to the flowchart of FIG. 9.

The detection controller 260 of the detector 26 starts the foreign object detecting process, for example, in response to an instruction from the power supplier 11. First, the detection controller 260 causes the components, such as the selector 264, to execute an initialization setting step, such as initialization of data and turning off of all the switches 246 and 248 (Step S100).

The detection controller 260 then determines whether the feature quantities have been acquired from all the loop coils 220A to 220X in the current detection cycle.

When the feature quantities have already been acquired from all the loop coils 220 (Step S102: Yes), the detection controller 260 proceeds to Step S112. When any of the loop coils 220 has not been subject to acquisition of the feature quantities (Step S102: No), the detection controller 260 proceeds to Step S104.

In Step S104, the detection controller 260 causes the selector 264 to select any one of the loop coils 220 that have not been subject to Steps S104 to S110 until that time.

The detection controller 260 then causes the driver 262 to drive the pulse generator 24 so that the pulse generator 24 generates a pulsed voltage (Step S106). The pulsed voltage is applied to both terminals T1 and T2 of the resonant circuit of the selected loop coil 220 via the external connector 224 and the connecting lines 230 and 232.

The converter 266 receives a vibration signal of the voltage V between both terminals of the resonant circuit of the loop coil 220 selected at the selector 264, and converts the received signal into data in a digital format (Step S108).

The waveform analyzer 268 extracts the feature quantities from the vibration signal in a digital format, and causes the extracted feature quantities to be stored into the storage 270 (Step S110). The process then returns to Step S102.

When the feature quantities have been acquired from all the loop coils 220, the process is subject to the determination of Yes in Step S102 and goes to Step S112.

The abnormality determiner 272 calculates the absolute values of the differences between the peak voltage Vₚ1, the time t_{d}1, and the frequency F1 acquired from one loop coil 220 contained in a certain group, and the peak voltage Vₚ2, the time t_{d}2, and the frequency F2 acquired from the other loop coil 220 contained in this group, that is, calculates the values |Vₚ1−Vₚ2|, |T_{d}1−T_{d}2|, and |F1−F2|, for each of the loop coils 220 (Step S112).

The abnormality determiner 272 compares the calculated absolute values with their reference values ThVₚ, ThT_{d}, and ThF. When any of the absolute values is the reference value or higher, that is, in the case of |Vₚ1−Vₚ2|≥ThVₚ or |T_{d}1−T_{d}2|≥ThT_{d} or |F1−F2|≥ThF, the abnormality determiner 272 determines that this group has abnormality (Step S114). In the following description, the condition of |Vₚ1−Vₚ2|≥ThVₚ or |T_{d}1−T_{d}2|≥ThT_{d} or |F1−F2|≥ThF is simply referred to as “any of the absolute values of the differences in the feature quantities is the reference value or higher” in order to simplify the description.

The abnormality determiner 272 determines whether any group is found in Step S114 to have abnormality (Step S116). When any group is determined to have abnormality (Step S116: Yes), the abnormality determiner 272 outputs a result indicating the existence of a foreign object. That is, the abnormality determiner 272 notifies the power supplier 11 of a result of determination indicating the existence of an abnormal group via the result outputter 274 (Step S118). In accordance with this notification, the power supplier 11 does not start the operation of wireless power transfer before the start of wireless power transfer, or immediately stops the operation of wireless power transfer during wireless power transfer. In contrast, when no group is determined to have abnormality in Step S116 (Step S116: No), the abnormality determiner 272 notifies the power supplier 11 of a result indicating the absence of an abnormal group via the result outputter 274 (Step S120). The power supplier 11 then starts the operation of wireless power transfer, or continues the operation of wireless power transfer. The result outputter 274 also outputs a result indicating the existence of a foreign object and information for identifying the position of the foreign object to an output device, such as display, and thus presents the result and information to the user.

In Step S122, the detection controller 260 determines whether an instruction to terminate the foreign object detecting process has been received from the power supplier 11. When a termination instruction has been received (Step S122: Yes), the detection controller 260 terminates the ongoing foreign object detecting process.

In contrast, when no termination instruction has been received (Step S122: No), the detection controller 260 returns to Step S102 and executes the above-described steps again.

A specific example of the above-described process is described below. The following description assumes an example in which a foreign object FO affecting the impedance of the coil 242 exists within the detection area of the loop coil 220A, as illustrated in FIG. 10A.

The detector 26 causes the pulse generator 24 to apply a pulsed voltage to each of the loop coils 220A to 220X and acquire the feature quantities of a vibration signal from each of the resonant circuits (Steps S102 to S110).

After completion of acquisition of the feature quantities from all the loop coils 220, the detector 26 calculates the absolute values of the differences in the feature quantities for two loop coils 220 contained in each group illustrated in FIG. 7 (Step S112). Since the foreign object exists only in the vicinity of the loop coil 220A in this example, the groups containing the loop coil 220A, that is, the group of the loop coils 220A and 220B and the group of the loop coils 220A and 220E result in relatively large absolute values of the differences in the feature quantities and are determined to have abnormality. In contrast, the two loop coils 220 contained in each of the other groups have approximately the same feature quantities, resulting in the absolute values of the differences of approximately 0.

The detector 26 then determines whether any of the absolute values of the differences in the feature quantities is the reference value or higher for each group (Step S114). In this example, the group of the loop coils 220A and 220B and the group of the loop coils 220A and 220E result in relatively large absolute values of the differences in the feature quantities, which are the reference values or higher, and are thus determined to have abnormality. Specifically, the group of the loop coils 220A and 220B and the group of the loop coils 220A and 220E are determined to have abnormality, because any of the absolute value of the difference in peak voltages Vₚ, the absolute value of the difference in times t_{d}, and the absolute value of the difference in frequencies F is the reference value or higher. In contrast, the absolute values are lower than the reference values in the other groups.

As described above, this embodiment can achieve detection of the existence of a foreign object.

The embodiment is capable of accurate detection of a foreign object by comparing the physical quantities of vibration signals from the resonant circuits of two loop coils 220 contained in a certain group and thereby canceling fluctuations affected by changes in environmental conditions.

The embodiment is capable of accurate detection of a foreign object because the detection is based on comparisons between one loop coil and each of other loop coils contained in two different groups.

The above-described grouping scheme of loop coils 220 is a mere example, and a group may contain combinations of two adjacent loop coils 220 other than the combinations illustrated in FIG. 7.

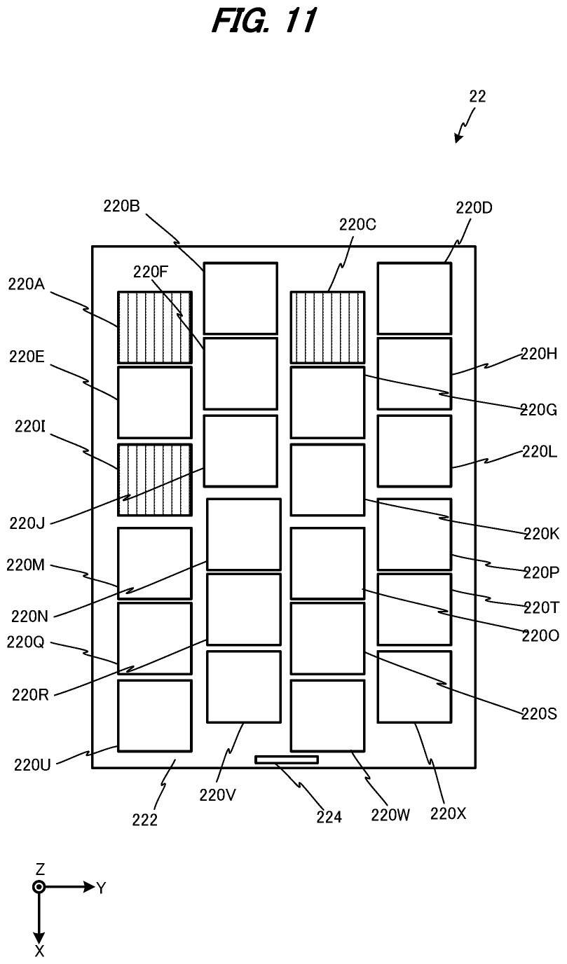

Although FIG. 7 illustrates exemplary groups of two adjacent loop coils 220, two loop coils 220 arranged apart from each other may be selected to form a group. For example, FIG. 11 illustrates an example in which a single loop coil is disposed between two loop coils 220 contained in the same group. In this example, the loop coils 220A and 220C form one group, and the loop coils 220A and 220I form another group. A column of the loop coils 220 is disposed between the loop coils 220A and 220C, and the loop coil 220E is disposed between the loop coils 220A and 220I.

Alternatively, loop coils 220 may be selected to form a group at random, in an irregular manner, or in an apparently irregular manner. In this case, the arrangement patterns of the loop coils 220 contained in multiple groups are at least partially different from each other.

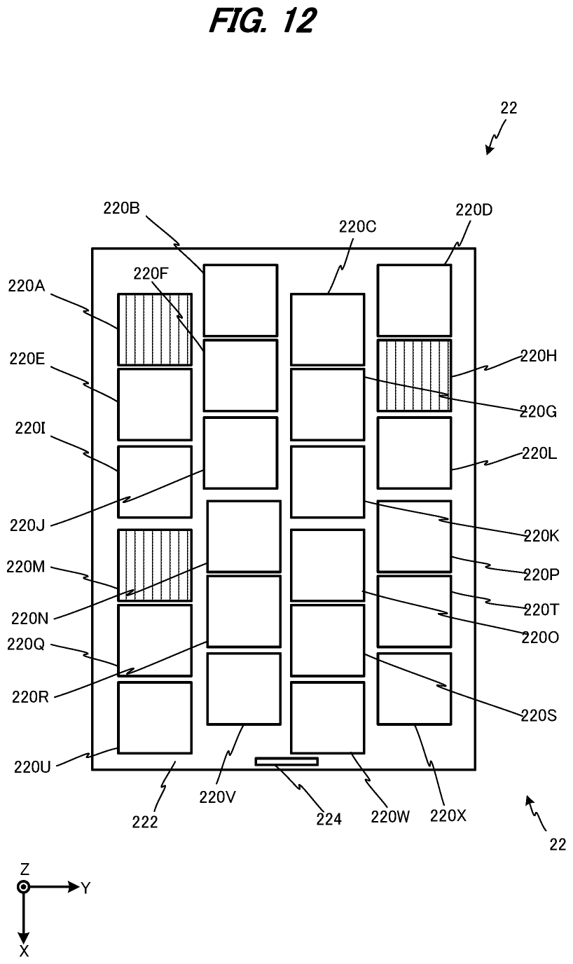

Alternatively, two loop coils 220 between which two or more loop coils 220 are disposed may be selected to form a group. For example, FIG. 12 illustrates an example in which the loop coils 220A and 220H form one group, and the loop coils 220A and 220M form another group. In this example, two columns of the loop coils 220 are disposed between the loop coils 220A and 220H, and two rows of the loop coils 220 are disposed between the loop coils 220A and 220M.

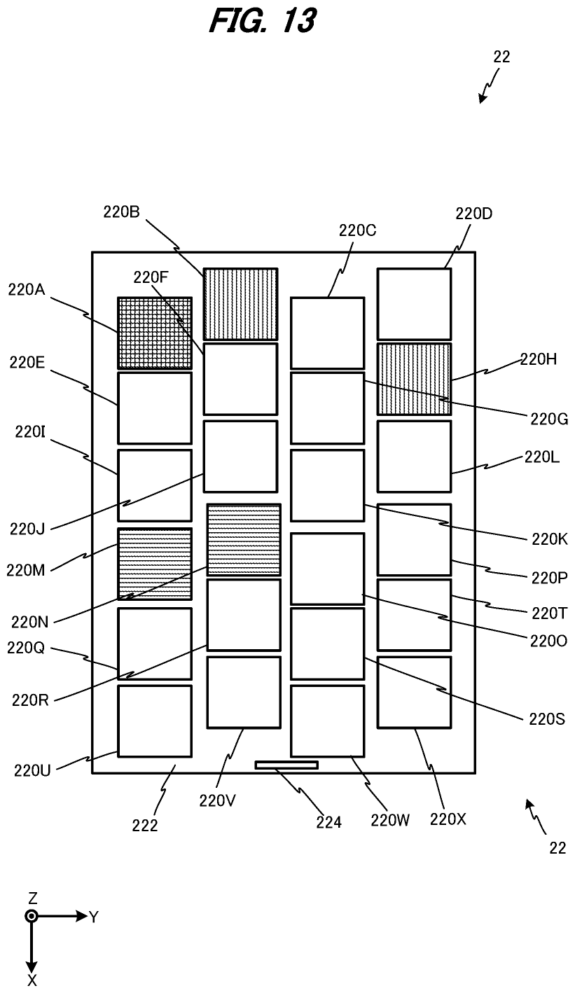

Although a single group contains two loop coils 220 in the above-described embodiment, a single group may contain three or more loop coils 220. For example, FIG. 13 illustrates an example in which the three loop coils 220A, 220B, and 220H form one group, and the three loop coils 220A, 220M, and 220N form another group. Alternatively, a single group may contain four or more loop coils 220.

In the case of a single group containing three or more loop coils 220, in Step S112 illustrated in FIG. 9, the absolute value of the difference in peak voltages Vₚ, the absolute value of the difference in times t_{d}, and the absolute value of the difference in frequencies F are calculated for all the pairs of loop coils 220 among the loop coils 220 contained in each group. In Step S114, on the basis of comparisons between the respective absolute values and the reference values, the group is determined to have abnormality when at least one of the absolute values is the reference value or higher.

In the above-described embodiment, each loop coil 220 belongs to two groups. When at least one of the two groups is determined to have abnormality, a foreign object is determined to exist in the vicinity of this loop coil 220.

Although the above-described embodiment is directed to an example in which the detection coil substrate 222 is made of a single substrate, the detection coil substrate 222 may also be made of a combination of multiple substrates.

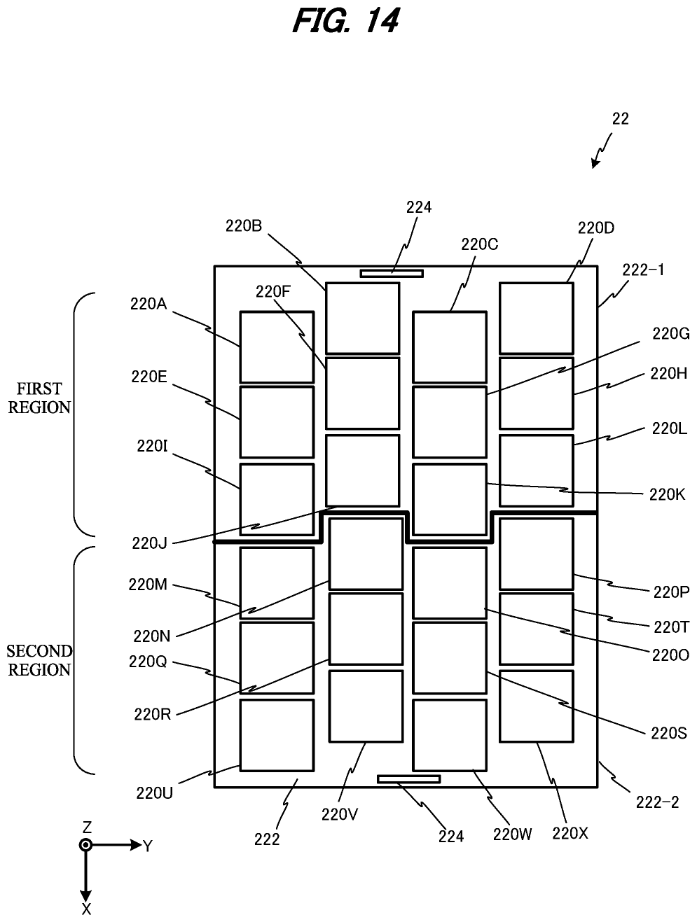

FIG. 14 illustrates an example in which a first substrate 222-1 and a second substrate 222-2 are combined to configure a single detection coil substrate 222. The first substrate 222-1 and the second substrate 222-2 have the identical structure and are combined back to back. In this case, the region on the first substrate 222-1 may be defined as a first region, the region on the second substrate 222-2 may be defined as a second region, first groups may contain only the loop coils 220 in the first region, and second groups (second coil groups) may contain only the loop coils 220 in the second region. In the second group, 1) different groups contain different combinations of loop coils 220, and 2) a loop coil 220 contained in a certain group is not contained in the other groups. A group of loop coils 220 corresponds to a group of coils 242 included in the loop coils 220 in other words. The arrangement patterns of the loop coils 220 contained in a group can be selected as appropriate, as in the first region. Alternatively, the region on the first substrate 222-1 may be defined as first and second regions, first groups may contain only the loop coils 220 in the first region, second groups (second coil groups) may contain only the loop coils 220 in the second region, the region on the second substrate 222-2 may be defined as first and second regions, first groups may contain only the loop coils 220 in the first region, and second groups (second coil groups) may contain only the loop coils 220 in the second region.

The configuration having both the first and second groups can reduce the number of groups in comparison to the configuration having only the first groups, and can therefore increase the speed of detection of a foreign object.

The loop coils 220 contained in each group may also be selected regardless of the regions. That is, some of the groups may contain the loop coils 220 in the first region and the loop coils 220 in the second region.

In the flowchart of FIG. 9, the existence of a foreign object is determined after acquisition of the feature quantities from all the loop coils 220. This configuration is not intended to limit the scope of the present disclosure. For example, the foreign object detecting process may be executed for the loop coils 220 contained in a certain group by acquiring the feature quantities necessary for determination of the existence of a foreign object, and then executed for the loop coils 220 contained in another group.

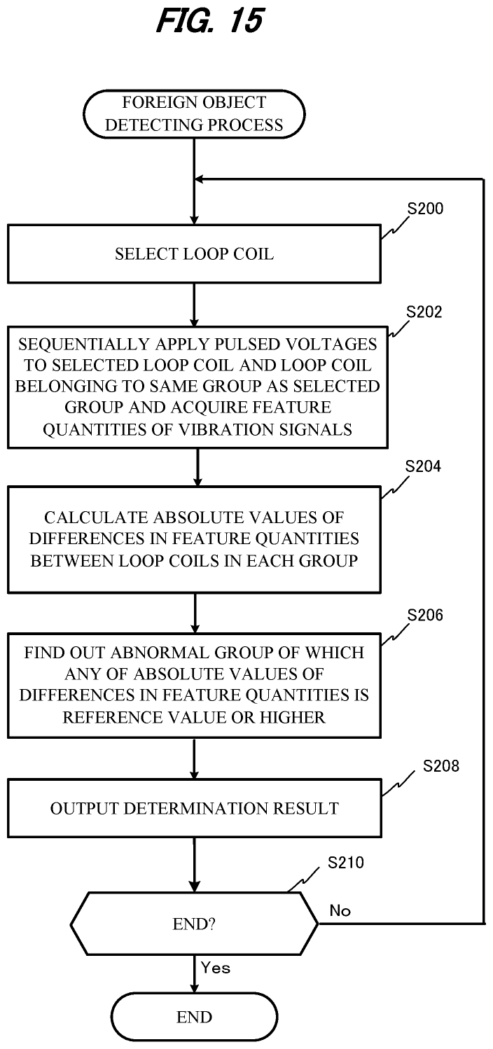

FIG. 15 illustrates an exemplary flowchart of the foreign object detecting process executed as described above. In this process, the detector 26 first selects a loop coil 220 to be used for detection of a foreign object (Step S200), causes the pulse generator 24 to apply a pulsed voltage to the selected loop coil 220, and acquires the feature quantities of a vibration signal. The detector 26 then causes the pulse generator 24 to apply a pulsed voltage to the other loop coil 220 belonging to the same group as the selected loop coil 220, and acquires the feature quantities of a vibration signal (Step S202). That is, the detector 26 causes the pulse generator 24 to sequentially apply pulsed voltages to the selected loop coil 220 and the other loop coil 220 belonging to the same group as the selected loop coil 220, and acquires the feature quantities of vibration signals. In this step, a pulsed voltage is not applied to the loop coils 220 not belonging to the same group as the selected loop coil 220.

The detector 26 then calculates the absolute values of the differences in the feature quantities between the selected loop coil 220 and the other loop coil 220 belonging to the same group (Step S204).

The detector 26 then determines whether any of the absolute values of the differences in the feature quantities is the reference value or higher (Step S206), and outputs s determination result (Step S208).

The detector 26 then determines whether the process has been terminated (Step S210). When the process has not been terminated (Step S210: No), the detector 26 returns to Step S200 and executes the same steps for the other loop coils 220. This configuration can also achieve accurate detection of a foreign object regardless of changes in environmental conditions. The above-described steps can be applied to both of the first and second coil groups but are preferably applied to the second coil group.

The feature quantities of a vibration signal used in the above-described embodiment are the physical quantities, such as frequency F, peak voltage Vₚ in the first cycle, and time t_{d} during which the peak voltage Vₚ is approximately halved, but may also be other physical quantities. Alternatively, only the frequency F, only the peak voltage Vₚ, or only the time t_{d} may be used as the feature quantities.

Although the effects of changes in environmental conditions are offset by calculating the absolute values of the differences in the feature quantities of vibration signals acquired from the loop coils 220 contained in a group in the above-described embodiment, the effects may also be offset by another effective procedure. For example, the ratio of the feature quantities of vibration signals acquired from two loop coils 220 may be calculated. A group of which the ratio falls approximately within a reference range of 1:1 may be determined to be normal, while a group of which the ratio is out of the reference range may be determined to be abnormal.

The openings of the coils 242 have a square shape in the above-described exemplary configurations, but may have another shape, such as rectangular, elliptical, or circular shape.

Although a pulsed voltage is applied from the pulse generator 24 to the individual loop coils 220 in the above-described embodiment, the voltage to be applied may also be a sinusoidal signal, for example. Alternatively, the power transmission coil 120 of the power transmission coil unit 12 may be excited, and a pulsed or sinusoidal magnetic field may be applied, for example.

Although the detection coil unit 22 of the foreign object detection device 20 is mounted on the upper surface of the power transmission coil unit 12 in the above-described embodiment, the detection coil unit 22 of the foreign object detection device 20 may also be mounted on the lower surface of the power reception coil unit 13 to detect a foreign object.

Although the loop coils 220 all belong to the first or second region in the above-described embodiment, this configuration is not intended to limit the scope of the present disclosure. For example, the loop coils 220 that are not contained in any group and the loop coils 220 contained in the first or second group may be arranged in a mixed manner on the detection coil substrate 222.

As described above, a foreign object detection device according to an aspect of the present disclosure includes: a plurality of coils arranged adjacent to each other on an arrangement surface, each of the coils being configured to be excited and thus generate a vibration signal; and a detector connected to the coils to detect the existence of a foreign object on the basis of the vibration signal output when each of the coils is excited. The arrangement surface has a first region in which the coils are grouped into a plurality of first coil groups each containing at least two coils, and the detector detects the existence of a foreign object on the basis of the vibration signal output from each of the coils contained in the first coil groups. The first coil groups contain mutually different combinations of coils, and one coil contained in at least one first coil group is also contained in another first coil group.

The foreign object detection device according to this aspect of the present disclosure is able to accurately detect the existence of a foreign object.

For example, at least some of the first coil groups may contain a combination of two adjacent coils between which at least one coil is disposed.

For example, the coils may be arranged only in the first region of the arrangement surface.

For example, the first coil groups may contain coils arranged in different arrangement patterns.

For example, the arrangement surface may have a second region in which the coils are grouped into a plurality of second coil groups each containing at least two coils, the detector may detect the existence of a foreign object on the basis of the vibration signal output from each of the coils contained in the second coil groups, and the second coil groups may contain mutually different coils.

For example, the second coil groups may contain coils arranged in different arrangement patterns.

For example, the detector may detect the existence of a foreign object on the basis of vibration signals output from coils contained in one of the first coil groups, and then detect the existence of a foreign object on the basis of vibration signals output from coils contained in another of the first coil groups.

For example, the detector may detect the existence of a foreign object on the basis of vibration signals output from coils contained in one of the second coil groups, and then detect the existence of a foreign object on the basis of vibration signals output from coils contained in another of the second coil groups.

A power transmission device according to another aspect of the present disclosure may include any of the above-described foreign object detection devices.

A power reception device according to another aspect of the present disclosure may include any of the above-described foreign object detection devices.

A power transfer system according to another aspect of the present disclosure may include a power transmission device and a power reception device, and at least one of the power transmission device or the power reception device may include any of the above-described foreign object detection devices.

The foregoing describes some example embodiment for explanatory purposes. Although the foregoing discussion has presented specific embodiment, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

The present disclosure is widely applicable to a foreign object detection device to detect a foreign object existing in the vicinity of a power transmission coil and a power reception coil, and to a power transmission device, a power reception device, and a power transfer system.

### REFERENCE SIGNS LIST

1 Power transfer system
2 Electric vehicle
3 Power transmission device
4 Power reception device
5 Rechargeable battery
11 Power supplier
12 Power transmission coil unit
13 Power reception coil unit
14 Rectifier circuit
15 Commercial power supply
20 Foreign object detection device
22 Detection coil unit
24 Pulse generator
26 Detector
120 Power transmission coil
122 Magnetic plate
130 Power reception coil
132 Magnetic plate
220 Loop coil
222 Detection coil substrate
224 External connector
230 First connecting line
232 Second connecting line
242 Coil
244 Capacitor
246, 248 Switch
250 Wiring pattern
260 Detection controller
262 Driver
264 Selector
266 Converter
268 Waveform analyzer
270 Storage
272 Abnormality determiner
274 Result outputter

1. A foreign object detection device, comprising:
a plurality of coils arranged adjacent to each other on an arrangement surface, each of the coils being configured to be excited and thus generate a vibration signal; and
a detector connected to the coils to detect existence of a foreign object on basis of the vibration signal output when each of the coils is excited, wherein
the arrangement surface has a first region in which the coils are grouped into a plurality of first coil groups each containing at least two coils, and the detector detects existence of a foreign object on basis of the vibration signal output from each of the coils contained in the first coil groups, and
the first coil groups contain mutually different combinations of coils, and one coil contained in at least one first coil group is also contained in another first coil group.

2. The foreign object detection device according to claim 1, wherein at least some of the first coil groups contain a combination of two adjacent coils between which at least one coil is disposed.

3. The foreign object detection device according to claim 1, wherein the coils are arranged only in the first region of the arrangement surface.

4. The foreign object detection device according to claim 1, wherein the first coil groups contain coils arranged in different arrangement patterns.

5. The foreign object detection device according to claim 1, wherein
the arrangement surface has a second region in which the coils are grouped into a plurality of second coil groups each containing at least two coils, and the detector detects existence of a foreign object on basis of the vibration signal output from each of the coils contained in the second coil groups, and
the second coil groups contain mutually different coils.

6. The foreign object detection device according to claim 5, wherein the second coil groups contain coils arranged in different arrangement patterns.

7. The foreign object detection device according to claim 1, wherein the detector detects existence of a foreign object on basis of vibration signals output from coils contained in one of the first coil groups, and then detects existence of a foreign object on basis of vibration signals output from coils contained in another of the first coil groups.

8. The foreign object detection device according to claim 5, wherein the detector detects existence of a foreign object on basis of vibration signals output from coils contained in one of the second coil groups, and then detects existence of a foreign object on basis of vibration signals output from coils contained in another of the second coil groups.

9. A power transmission device, comprising:
the foreign object detection device according to claim 1.

10. A power reception device, comprising:
the foreign object detection device according to claim 1.

11. A power transfer system, comprising:
a power transmission device; and
a power reception device, wherein
at least one of the power transmission device or the power reception device comprises the foreign object detection device according to claim 1.
